(19) United States
(12) Patent Application Publication
(10) Pub. No.: US 2021/0114677 A1
(43) Pub. Date: Apr. 22, 2021

(54) METHOD OF MAKING A SADDLE AND RELATED SADDLE

(71) Applicant: SELLE ITALIA S.R.L., Asolo (Treviso) (IT)

(72) Inventors: Riccardo PEROTTO, Asolo (Treviso) (IT); Giuseppe Bigolin, Asolo (Treviso) (IT)

(21) Appl. No.: 17/071,564

(22) Filed: Oct. 15, 2020

(30) Foreign Application Priority Data
Oct. 16, 2019 (IT) 102019000018995

(51) Int. Cl. B62J 1/26; B62J 1/00

(52) U.S. Cl. CPC B62J 1/26; B62J 1/002

(57) ABSTRACT

A method of making a saddle having a shell and a padding involves arranging the shell in thermoplastic polymer inside a mould for injection moulding having a die and a punch, the shell having a support surface, which in use faces the padding, and a supporting surface coupled to an inner wall of the punch or of the die, the support surface forming a wall of the moulding cavity; closing the mould; and making the padding by injection moulding a thermoplastic polymer over the shell, between the support surface and the mould.

### CROSS-REFERENCE TO RELATED APPLICATION

This application claims priority to Italian Patent Application No. 102019000018995 filed on Oct. 16, 2019, the entire contents of which is hereby incorporated in its entirety by reference.

### FIELD OF THE INVENTION

The present invention relates to a method of making a saddle and a related saddle. In particular, the present invention relates to a method of making a bicycle saddle.

In the following description, particular reference will be made to a bicycle saddle; however, the principles of the present invention may be applied also to saddles intended for different uses.

### BACKGROUND OF THE INVENTION

As it is known, bicycle saddles essentially comprise a frame, a shell, a padding and an outer coating.

The frame, whose functions are to allow the saddle to be connected to the saddle post and to act as a mechanical support for the shell, is normally made of metal or composite material. The shell, made of hard and rigid plastic material, is the element which gives rigidity to the saddle, acting as a support surface for the padding.

The padding, commonly made of polyurethane foam, is comprised between the shell and the outer coating.

As it is known, a method of making saddles of this type comprises a first step in which a coating material is prepared inside a mould, which comprises a countershape surface with respect to the support surface of the saddle.

Once the coating material is positioned, it must be placed in contact with the countershape surface of the mould, in a manner as adherent as possible, so that it precisely reproduces the surface of the mould itself. In this regard, means adapted to create a vacuum (with a certain residual pressure) between the surface of the mould and the coating material, so that the latter adheres to the surface of the mould, are conventionally used.

On the second half of the mould, which reproduces in negative the lower surface of the shell, a shell is positioned, so that the inner side thereof, which in use will face the padding, is visible.

Subsequently, a foamed material in liquid form, for example polyurethane, is poured onto the first half of the mould, and therefore onto the inner side of the coating material.

The mould is then closed, and the polyurethane is allowed to cure. In this case, the polyurethane foam acts as a padding and at the same time as a binder between the shell and the coating material.

The time required for curing the polyurethane foam is about six minutes. Once the curing is obtained, the mould may be opened and the saddle may be extracted from the mould itself.

At this point, operations, usually manual, may be necessary to trim the excess edges of the coating material.

Alternatively, it is possible to make the foam padding separately, with a method similar to the previous one, and then fix the various components together using specific adhesives or glues.

The background art, although widely appreciated, is not free from drawbacks both from the point of view of the production thereof and from the point of view of the comfort for the user.

The method of the background art requires very long cycle times, at least of about six minutes, the time necessary for the polyurethane foam to cure. To this cycle time, time required to restore the equipment for the production of the next saddle must also be added.

Furthermore, this method involves multiple interventions of the operator since most of the steps are managed and carried out by specialized operators.

Furthermore, the use of glues or adhesives to fix the various components to one another creates a disadvantage in terms of environmental impact, both for the use of these substances themselves, and for the possible recyclability of the various materials with which the saddle is made.

From the point of view of the comfort of the saddle, there is an intrinsic inability of polyurethane to respond to tangential stresses since the reaction thereof to an applied stress is a simple compression. Therefore, it is not particularly adapted to accompany in an integral manner the translation of the pelvis/ischial bones of the user during use.

### SUMMARY OF THE INVENTION

Thus, a need is felt to solve the drawbacks and limitations mentioned above with reference to the background art.

Therefore, a need is felt for a method of making a saddle which allows for very short cycle times, compared to the methods of the background art.

Furthermore, a need is felt for a method of making a saddle subject to limited manual operations by operators.

In addition, a need is felt for an eco-sustainable method of making a saddle, using completely recyclable materials and avoiding use of glues and adhesives.

In addition, the need is felt for a saddle which is more comfortable than traditional saddles made with polyurethane foam.

In particular, there is a need for a more effective saddle in accompanying in an integral manner translation of the pelvis/ischial bones of the user during use.

Such requirements are, at least partially, met by a method of making a saddle and a saddle as described and claimed herein.

### BRIEF DESCRIPTION OF THE DRAWINGS

Further features and advantages of the present invention will become more comprehensible from the following description of preferred embodiments thereof given by way of non-limiting examples, in which:

FIG. 1 diagrammatically shows a perspective view of a saddle according to the present invention;

FIG. 2 diagrammatically shows a rear view of a saddle according to the present invention;

FIG. 3 diagrammatically shows a perspective view of two components of the saddle according to the present invention;

FIG. 4 diagrammatically shows a cross-section of a mould and of a saddle portion during a step of the method of making a saddle according to the present invention;

FIG. 5 diagrammatically shows a cross-section of a mould and of a saddle during a step of the method of making a saddle according to the present invention;

FIG. 6 diagrammatically shows a cross-section of a mould and of a saddle during a step of the method of making a saddle according to the present invention; and

FIGS. 7 and 8 diagrammatically show two saddle sections according to two possible embodiments of the present invention.

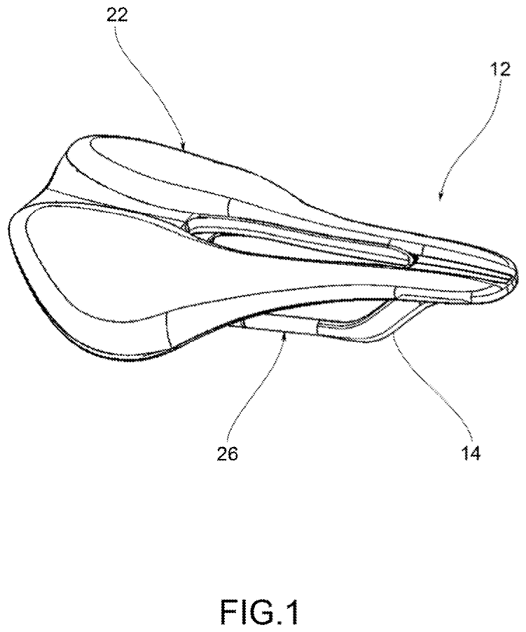

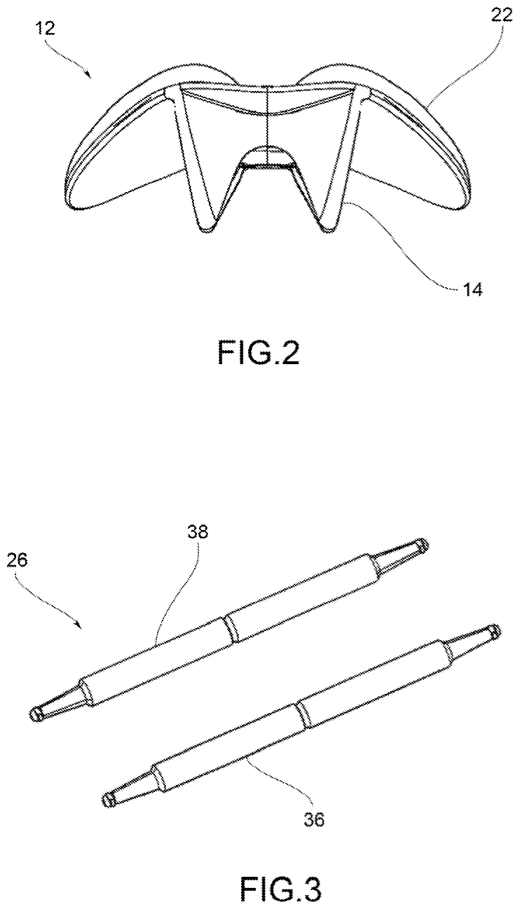

Elements or parts in common to the embodiments described will be indicated hereafter using the same reference numerals.

### DETAILED DESCRIPTION

The method of making a saddle 12 comprising a shell and a padding 22 according to the present invention comprises the steps of:

(a) arranging a shell 14 in thermoplastic polymer inside a mould 16 for injection moulding, comprising a die 18 and a punch 20, 32; the shell 14 comprising a support surface 15, which in use faces said padding 22, and a supporting surface 17 coupled to an inner wall of the punch 20, 32 or of the die 18, the support surface 15 forming a wall of the moulding cavity;

(b) closing the mould 16; and

(c) making the padding 22 by injection moulding a thermoplastic polymer over said shell 14, between the support surface 15 and the inner surface of said mould 16.

The polymer used in step (c) may be a thermoplastic elastomer TPE.

According to a possible embodiment, the thermoplastic polymer used for the padding may be an SBS rubber (styrene-butadiene-styrene rubber).

According to a possible alternative embodiment, the thermoplastic material used for the padding may be the one marketed under the name PEBAX®.

According to a first embodiment of the present invention, the padding has a uniform hardness. For example, the padding 22 may have a hardness between 5 and 60 shore A.

Therefore, in other words, the padding 22 may be made with a single thermoplastic polymer, as shown in the example of FIG. 8.

According to a possible embodiment, the padding 22 may comprise an outer coating 28 having a hardness between 5 and 60 shore A, and an inner core 30 with a hardness lower than the hardness of the coating 28.

Advantageously, the inner core 30 may have a hardness between 0 and 5 shore A. Preferably, the inner core 30 may have a hardness around 0 shore A.

In this case, the padding 22 is made by co-injection moulding of:

a coating 28 which forms an outer coating 28 of the padding 22, and also forms the contact with the surface of the shell 14, and

an inner core 30 with reduced hardness.

In other words, the padding 22 may be made with a coating 28 and an inner core 30 with a lower hardness.

The thermoplastic polymer with which the outermost layer of the padding is made, which in both cases corresponds to a material with a hardness between 5 and 60 shore A, allows direct fixing of the padding material, by means of a chemical bond, to the shell 14.

In the case in which an inner core 30, with a reduced hardness, and in particular lower than 5 shore A, is provided, the coating 28 allows to effectively fix the polymer, with which the inner core 30 is formed, to the shell 14. In other words, the thermoplastic polymer with greater hardness allows the fixing not only to the shell 14, but also to the inner core 30, allowing exploiting the mechanical properties thereof.

Furthermore, the coating 28 made with a thermoplastic polymer, in particular SBS rubber having a hardness between 5 and 60 shore A, allows to obtain:

wear resistance (determined, for example, by rubbing against the clothing of the user),

impermeability; and

surface friction control, which may be varied according to specific requests, for example, by adding additives.

According to a possible embodiment of the present invention, the shell 14 is made of thermoplastic material with a high elastic modulus and a high hardness.

The shell 14 may be made of thermoplastic material, for example, of copolymer polypropylene.

The copolymer propylene used may possibly be of the loaded type. In particular, the copolymer polypropylene may be loaded with loads of a type per se known, such as fiberglass, carbon, and/or talc, etc.

Advantageously, the shell may be made of copolymer polypropylene loaded with a percentage of fibreglass between 5% and 15%, preferably around 10%.

In this case, the elastic modulus of a copolymer polypropylene loaded with a percentage of fibreglass of about 10% may have an elasticity modulus higher than 2000.

This solution of a copolymer polypropylene loaded with a percentage of fiberglass of about 10%, allows achieving an optimal fixing of the thermoplastic elastomer with which the padding is made, especially in the case of SBS material.

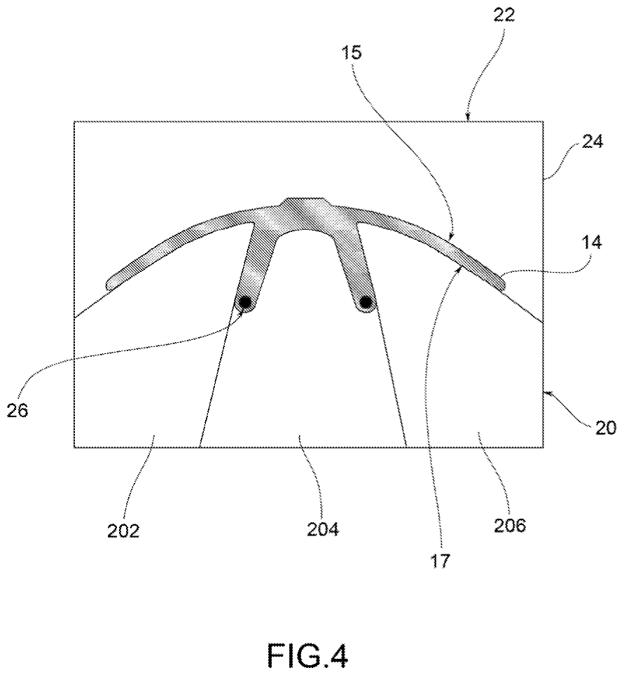

FIG. 4 shows a step of making the shell 14. According to a possible embodiment, the shell 14 may be made by injection moulding in a mould 22 comprising the punch 20 and a second die 24.

As it may be seen in the Figures, the punch 20 may be made with inserts 202, 204, 206 so as to create particular undercuts and allow the extraction of the shell from the mould. Such type of equipment is per se known to those skilled in the art and therefore it will not be further explored.

In the same manner, the ducts for feeding the polymer into the mould cavity are not shown, since they are elements per se known to those skilled in the art as well.

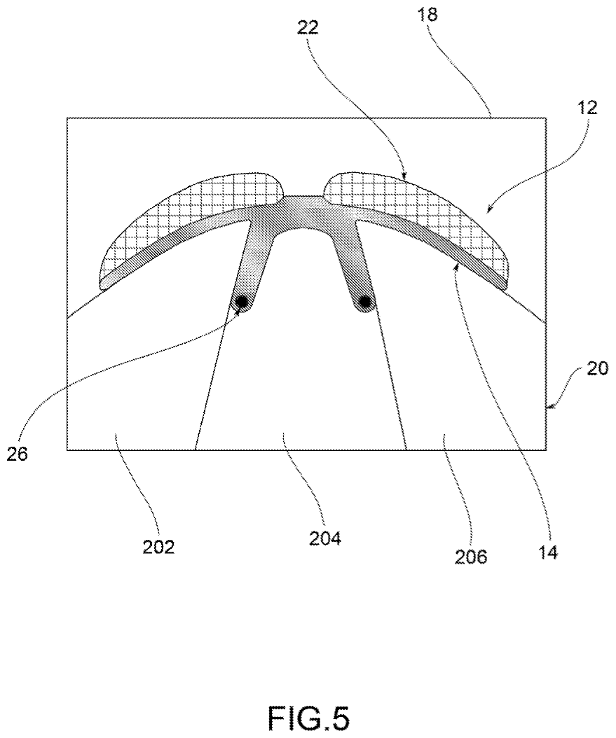

Once the shell 14 is made, the mould is opened and the second die 24 is replaced with the matrix 18 to injection mould the padding 22. This mode is shown, for example, in FIG. 5, in which the punch 20 is the same, while the shape of the die 18, which has now a countershape with respect to the padding 22, has changed.

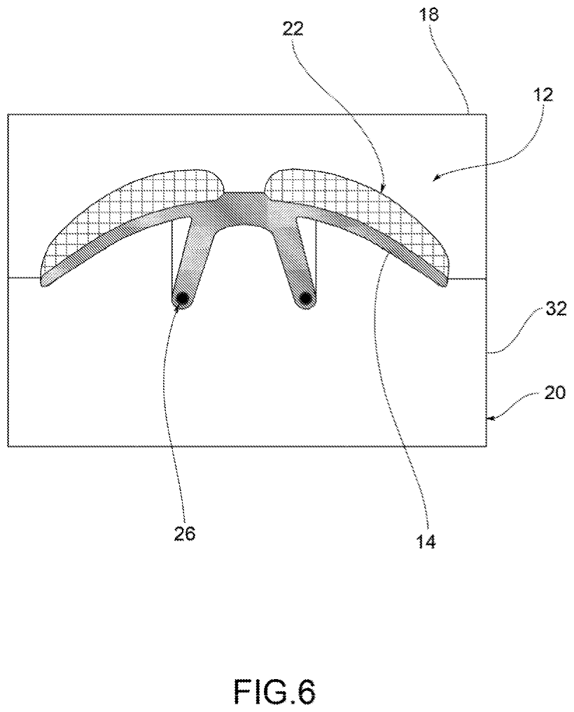

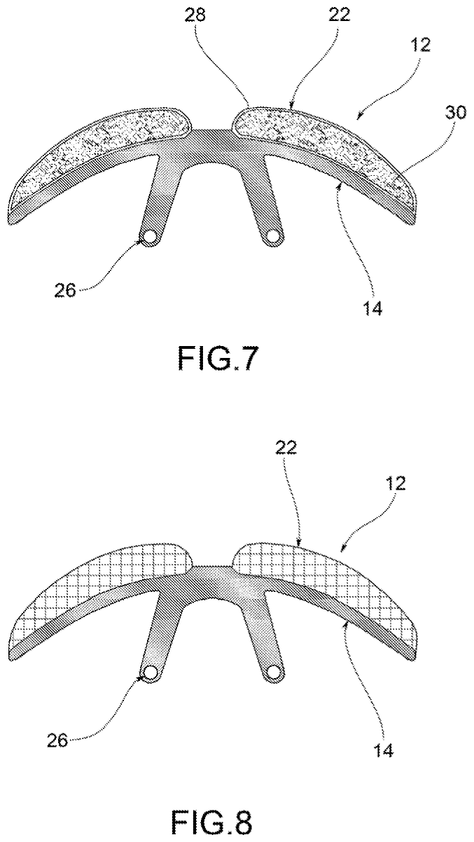

In FIG. 6, on the other hand, an alternative embodiment is shown, in which the shell 14, once made, is removed from the mould 16 and is positioned in a second punch 32, next prepared with a second die 24.

In this case, the shell 14 is therefore made by injection moulding inside a dedicated mould and is subsequently placed inside the mould comprising the die 24 adapted to make the padding 22.

From the point of view of the manufactured saddle, the two methods are substantially equivalent. From a production point of view, the second method allows to divide the moulding times on two machines, with the possibility of further reducing the production times, and of creating a certain quantity of frame-shell subsets stock which may then be over moulded in another machine.

According to a possible embodiment, the shell 14 may be made by injection moulding, over moulding a frame 26.

FIG. 3 shows a possible embodiment of a frame 26. In particular, the frame 26 may comprise two bars 36, 38, which may be made of metal, thermoplastic material, and/or composite material.

Advantageously, said bars may be made of C40.

As it may be seen in FIG. 3, the bars 36, 38 may comprise tapered ends, arranged with radial projections adapted to allow a better adhesion to the thermoplastic material of the shell.

The advantages which may be achieved with a method of making a saddle and the related saddle according to the present invention are therefore evident.

First of all, the method, and therefore the materials used, allow to improve performance of the product, especially in terms of comfort.

Furthermore, they allow increasing the eco-sustainability and the recycling of the materials used.

The operations required to the operators during the manufacturing of the saddle significantly decrease.

In addition, production costs significantly decrease since cycle times significantly decrease.

In this regard, the time required for the moulding cycle of a saddle 12, according to the method of the present invention, is a very short time, of the order of one minute. Therefore, the cycle time is significantly lower than the cycle time of about six minutes required in the case of polyurethane padding.

Furthermore, a method of making a saddle and a related saddle are provided, the method allowing obtaining a more comfortable saddle than traditional saddles made with polyurethane foam. In particular, the saddle of the present invention is adapted to accompany, in an integral manner, translation of the pelvis/ischial bones of the user during use.

Furthermore, a method is provided in which, by modifying some additives used during the injection moulding, it is possible to control the mechanical properties of the outer surface of the saddle, without thereby significantly changing the properties of the material of which the inner core of the padding is made.

To the embodiments described above, those skilled in the art will be able to make changes and/or substitutions of elements described with equivalent elements without thereby departing from the scope of the present invent as described and claimed herein.

What is claimed is:

1. A method of making a saddle comprising a shell and a padding, the method comprising the steps of:
(a) arranging the shell in thermoplastic polymer inside a mould for injection moulding, comprising a die and a punch; said shell comprising a support surface, which in use faces said padding, and a supporting surface coupled to an inner wall of said punch or of said die, said support surface forming a wall of the moulding cavity;
(b) closing the mould; and
(c) making the padding by injection moulding a thermoplastic polymer over said shell, between said support surface and said mould.

2. The method of claim 1, wherein the thermoplastic polymer used in step (c) is a thermoplastic elastomer (TPE).

3. The method of claim 1, wherein the thermoplastic polymer used in step (c) is a SBS rubber.

4. The method of claim 1, wherein said padding is made by co-injection moulding of a coating forming an outer coating of said padding and forming a contact with the surface of said shell, and an inner core of reduced hardness.

5. The method of claim 4, wherein said coating has a hardness between 5 and 60 shore A, and said inner core has a hardness between 0 and 5 shore A, preferably 0 shore A.

6. The method of claim 1, wherein said shell is made by injection moulding in a mould comprising the punch and a second die.

7. The method of claim 1, wherein said shell is made by injection moulding inside a dedicated mould and is subsequently placed inside the mould.

8. The method of claim 1, further comprising a step in which the shell is made by injection moulding, over moulding a frame.

9. The method of claim 1, wherein said shell is made of copolymer polypropylene loaded with a percentage of fiberglass between 5% and 15%, preferably around 10%.

10. A saddle comprising a shell and a padding; said shell being made of thermoplastic polymer comprising a support surface which, in use, faces said padding and a supporting surface, said padding being made by a thermoplastic polymer injection moulded directly onto said support surface of said shell.

11. The saddle of claim 10, wherein said shell is made of copolymer polypropylene loaded with a percentage of fiberglass between 5% and 15%, preferably around 10%.

12. The saddle of claim 10, wherein said padding is made of thermoplastic elastomer TPE, preferably an SBS rubber.

13. The saddle of claim 10, wherein said padding comprises a coating forming an outer coating of said padding and forming a contact with the surface of said shell, and an inner core of reduced hardness.

14. The saddle of claim 13, wherein said coating has a hardness between 5 and 60 shore A, and said inner core a hardness between 0 and 5 shore A, preferably 0 shore A.
